(19) United States
(12) Patent Application Publication
(10) Pub. No.: US 2023/0271235 A1
(43) Pub. Date: Aug. 31, 2023

(54) ADVANCED REACTOR FOR THE THERMAL CHEMICAL CONVERSION OF MUNICIPAL SOLID WASTE

(71) Applicant: Bright Sand, Inc., Chattanooga, TN (US)

(72) Inventor: Earl R. DECKER, Windsor (CA)

(73) Assignee: Bright Sand, Inc., Chattanooga, TN (US)

(21) Appl. No.: 18/172,241

(22) Filed: Feb. 21, 2023

Related U.S. Application Data
(63) Continuation-in-part of application No. 16/796,633, filed on Feb. 20, 2020, now Pat. No. 11,584,893.
(60) Provisional application No. 62/807,798, filed on Feb. 20, 2019.

(51) Int. Cl. B09B 3/40; B09B 3/70; F23G 5/36; F23G 5/08

(52) U.S. Cl. CPC B09B 3/40; B09B 3/70; F23G 5/36; F23G 5/08; F23G 2202/30

(57) ABSTRACT

An advanced single canister reactor system for the advanced thermal chemical conversion processing of municipal solid waste (“MSW”), either sorted or unsorted, and autoclaves specially designed to process the waste at suitable temperature and pressure combinations is disclosed. The canister having at least one support structure mounted therein with at least one compression relief structure pivotally attached to the support structure. The compression relief structure is pivotable between a first position that is parallel to the wall, and a second position that is orthogonal to the wall, so that the compression relief structure prevents compression of waste materials loaded into the canister.

### RELATED APPLICATIONS

The present application is a continuation-in-part application claiming benefit from earlier filed U.S. patent application Ser. No. 16/796,633, filed Feb. 20, 2020, now U.S. Pat. No. 11,584,893, issued Feb. 21, 2023, which claims priority from U.S. Provisional Application No. 62/807,798, filed Feb. 20, 2019, all of which are incorporated by reference in their entireties for all purposes.

### BACKGROUND

### Field of Invention

The present disclosure relates to a process and equipment to process sorted and unsorted municipal solid waste (hereinafter “MSW”) to produce energy, typically in the forms of electricity or heat. The system process allows for the maximum amount of energy to be retained, hydrocarbons to be driven from the MSW and syngas with an increased BTU value to be produced. This disclosure provides processes, methods and equipment to enhance the BTU value, or quality, of the syngas produced as well as significantly reduce the overall volume of waste. The waste can be reduced by up to 95% of its original volume while simultaneously reducing greenhouse gas emissions by up to 95%.

The present disclosure is directed to reactor designs optimized for thermal decomposition of MSW, particularly MSW containing both loose items and cylindrical compressed bales of MSW.

### Discussion of the Related Art

There are numerous methods to convert MSW to energy, from thermal decomposition, thermal degradation, gasification, plasma arc to liquification. Each of these methods reduces MSW and produces a gas and/or latent heat to generate energy.

Thermal decomposition can process unsorted MSW and produce heat that is used to operate boilers which in turn operate turbines to produce electricity.

Gasification usually involves sorting the MSW, sizing (usually, grinding), drying and reforming the raw MSW into pellets prior to feeding into the gasification unit.

Pyrolysis generally involves sorting to remove unsuitable materials, then heating in the absence of oxygen resulting in the breakdown of the MSW into liquid hydrocarbons and syngas.

Unfortunately, landfilling is currently the most popular method of disposing of waste. This disposal method involves little capital investment to simply transport the waste to a suitable location to be dumped and covered. Additionally, municipal solid waste is currently one of the largest single producers of the greenhouse gas, methane, from countless landfills. The gas is generated from decomposing waste and it seeps into the atmosphere continually.

Clearly there is a need for a process, and equipment to carry out the disposal process which will convert the large amounts of MSW into a green energy source while also reducing the volume of the MSW.

### SUMMARY OF THE DISCLOSURE

The present disclosure is directed to canisters to hold waste feedstock, and autoclaves specially designed to process the waste at suitable temperature and pressure combinations. Disclosed is a reactor for thermal processing of waste materials including a canister having an interior defined by a wall with at least one support structure mounted on the wall, and at least one compression relief structure pivotally attached to a respective one of the support structures. The compression relief structure is pivotable between a first position that is parallel to the wall, and a second position that is orthogonal to the wall.

The compression relief structures can pivot out of the way when MSW is initially loaded into the canister, then pivot to a position orthogonal to the interior wall to prevent compression of the loaded MSW when even more MSW is loaded into the canister. With one or more support structures mounted on the interior wall, and the compression relief structures pivoted to the orthogonal position, the compression forces on the MSW loaded into the canister are decreased.

Additionally, disclosed is a canister or reactor for the thermal processing of waste material made up of a canister, a floor structure at the bottom of the canister, a heated air opening located in the floor structure in the canister, and a conical structure centrally positioned above the heated air opening. A carbon pillow can be positioned around the conical structure and configured to prevent the heated air from directly contacting the waste material. As used herein, a canister generally refers to a cylindrical shaped vessel.

### BRIEF DESCRIPTION OF THE DRAWINGS

The accompanying drawings, which are included to provide a further understanding of the invention and are incorporated in and constitute a part of this specification, illustrate embodiments of the invention and together with the detailed description serve to explain the principles of the invention. The drawings represent an illustration of some of the embodiments of the present invention and are not to be construed as limiting the scope of the invention in any manner. Some of the drawings may not show all of the features and components of the invention for ease of illustration, but it is to be understood that where possible, features and components from one drawing may be included in the other drawings. Further, the drawings are not necessarily to scale, some features may be exaggerated to show details of particular components. Therefore, specific structural and functional details disclosed herein are not to be interpreted as limiting, but merely as a representative basis for teaching one skilled in the art to variously employ the present invention. In the drawings:

FIGS. 1A, 1B, 1C, 1D, and 1E are plan drawings with details of a compression relief structure and canister according to various embodiments of the present disclosure;

FIG. 2 is a general schematic of an autoclave and gas handling device according to one embodiment of the present disclosure, and

FIGS. 3A and 3B are plan drawings of details of the canister and reactor according to various embodiments of the present disclosure.

### DETAILED DESCRIPTION

In the presently disclosed system, the MSW can be received in either loose or baled. In either case, the material can be placed inside cylindrical canisters which are then placed inside an autoclave to be thermally processed. One feature of the presently disclosed system is when baled MSW is processed there is no need for the bales to be opened prior to being placed into a canister section, that is, the entire compressed bale can be placed into the canister section as received from the baler. The canister can be loaded with either a bale of MSW or loose MSW, or in some cases, a mixture of the two, and then lifted into the autoclave and placed into position.

In some instances, it may be preferable to first place loose MSW in the canister and then add a bale of compressed MSW. In order to prevent the bale from compressing the loose MSW and negatively impacting the completeness of its thermal conversion, the presently disclosed compression relief structures can be utilized to prevent the unwanted compression by holding the bale above the loose MSW. In other instances, the compression relief structures can be utilized between two or more bales of compressed MSW. In many such embodiments, liquid wastes can be added to the canister. In yet other instances between larger pieces of refuse such as, for example, tires, furniture, appliances, and so forth.

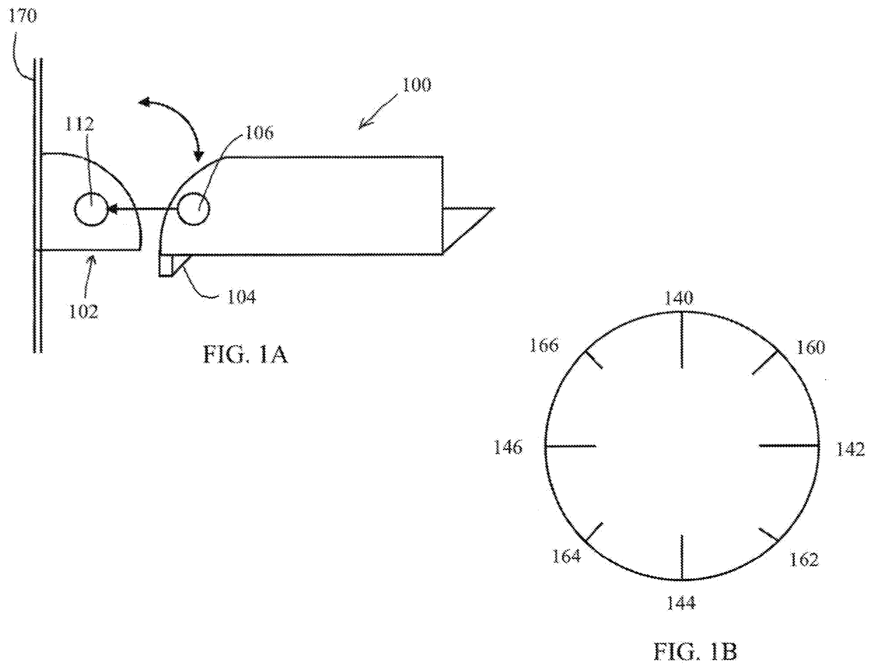

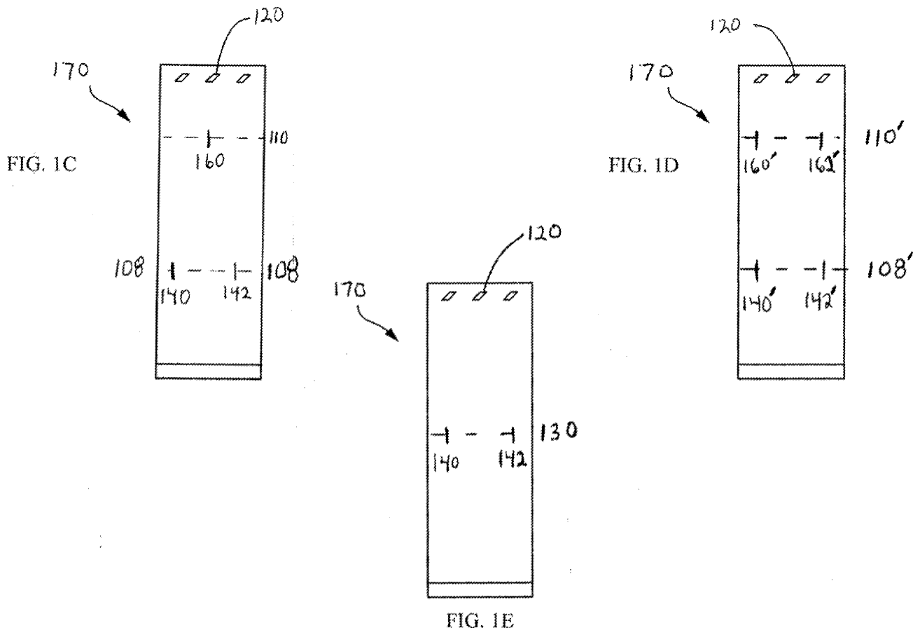

The compression relief structures can be pivotably, rotatably and detachably attached to support structures that can be mounted in various configurations in the presently disclosed canister. In some embodiments, the support structures 140, 142, 144, 146 can be mounted in the midplane 130 of the canister as illustrated in FIG. 1E. In some embodiments, the support structures can be mounted with a first set 140, 142, 144, 146 in a first plane 108 symmetrically spaced around the internal circumference of the canister, and a second set 160, 162, 164, 166 mounted in a second higher plane 110 symmetrically spaced, but offset from the first set, around the internal circumference of the canister. In other embodiments, the second set of support structures 160′, 162′, 164′, 166′ can be located directly above the first set of support structures, as illustrated in FIG. 1D.

For some embodiments of the present disclosure, there can be 2, 3, 4, or more support structures for the compression relief structures symmetrically arranged around the internal circumference of the canister. In other embodiments, the support structures for the compression relief structures can be in a nonsymmetrical arrangement about the internal circumference of the canister.

In various other embodiments of the present disclosure, the compression relief structures can be positioned in an angled position between the first plane 108 and the second plane 110. In other embodiments, the compression relief structures can be located in more than two planes, or in other arrangements can be in non-planar arrangements.

In other embodiments of the present disclosure, the support structures can be replaced with openings in the canister wall to allow for the compression relief structures to enter the opening, span the canister, and then insert into a corresponding opening on the opposite interior wall of the canister. The two corresponding openings can be diametrically opposed to one another or can be non-antipodal. in some embodiments, the compression relief structures will cross the center of the canister. In some embodiments of the presently disclosed canister, the compression relief structures can enter an opening in one plane 108 and insert into an opening in another plane 110, and vice versa. Prior to installation into the autoclave the openings can be closed with appropriate closing structures.

In some embodiments of the present teachings, the canisters are further equipped with compression relief structures 100 to prevent further unwanted compression of waste materials loaded into the canister. In some embodiments, the compression relief structures 100 can be located at two levels of the canister 170, one level 108 at approximately one-third of the canister height, and a second level 110 at approximately two-thirds of the canister height. In other embodiments of the present teachings, there can be more levels of relief structures 100 positioned at different heights inside the canister 170. For instance, the relief structures 100 can be arranged in a “staircase” arrangement spiraling up and around on the inside of the canister, or “randomly” staggered arrangements can be utilized. In other embodiments of the present disclosure, the compression relief structures can be located or spaced in irregular or random locations on the interior of the canister to provide flexibility to the loading of the canister with MSW.

The compression relief structures 100 can be attached to the inside wall of the canister so that when the canister is in an upright vertical position for loading of MSW, loose or baled, the compression relief structures 100 will pivot to a parallel orientation to the interior wall so that the movement of the MSW to the bottom of the canister is not impeded. The compression relief structures 100 can then pivot to an orientation orthogonal to the interior wall, and thus prevent compression of the MSW already loaded below the compression relief structure. After thermal chemical processing of the MSW, the canister can be rotated to an inverted vertical position, and the compression relief structures 100 can fold up against the inside wall, or pivot back to the parallel orientation to the interior wall so that the movement of the processed MSW out of the canister is not impeded.

Thus, in the various embodiments of the present disclosure, when the canister is inverted to remove the contents therein, the compression relief structures can fold up against the inside wall to allow all of the contents to exit the canister. Those of skill in the art will recognize various ways to achieve the desired actions of the compression relief structures 100. FIG. 1A is a stylized view down the open top of the canister.

The exemplar embodiment illustrated in FIGS. 1A and 1C has relief structures 100 located at positions 140, 142, 144, and 146 on level 108, with a second set of relief structures 100 located at positions 160, 162, 164, and 166 on level 110. In this embodiment, the compression relief structures in one plane 108 are offset from the second plane 110.

The exemplar embodiment illustrated in FIG. 1D has relief structures 100 located at positions 140′, 142′, 144′, and 146′ on level 108′, with a second set of relief structures 100 located at positions 160′, 162′, 164′, and 166′ on level 110′. Here, the compression relief structures in one plane 110′ are located directly above the compression relief structures in the other plane 108′.

As illustrated in FIG. 1B, the compression relief structures 100 can be attached to the inside wall of the canister 170 by support structure 102 with through holes 106 and 112 lining up so that a pin (not shown) can be inserted into the through holes 106 and 112 to pivotally attach the compression relief structure 100. As illustrated, this embodiment includes a stop 104 to provide additional support to the overall compression relief structure 100. In some embodiments of the present disclosure, the compression relief structure and the support structure can form a 90 degree pivot joint so that the compression relief structure pivots from a parallel orientation to the wall for loading, and unloading, to an orthogonal orientation to the wall for thermal processing of the waste materials.

In some embodiments, the compression relief structures can be a solid structure as shown in FIGS. 1B and 1n other embodiments, the compression relief structures can be composed of perforated or slotted material, rods, angled struts, I-beams, engineered truss, and other designs with sufficient strength to perform as needed.

In some embodiments, a retaining mechanism can be incorporated into the overall support structure to maintain the compression relief structure in a vertical or parallel to the wall orientation. Exemplary retainer mechanisms can include retainer pins or stops in the support structure 102, or spring loaded mechanisms. One of ordinary skill in the art would recognize the possible retaining mechanisms that would perform under the operating conditions of the canister.

The combined horizontal lengths of diametrically opposing compression relief structures 100, for instance, at positions 140 and 144, or positions 142 and 146, or positions 160 and 164, or positions 162 and 166, can be equal to 99%, 90%, 80%, 70%, 60%, 50%, 40%, 30%, 20%, 10%, or 5%, respectively, of the inside diameter of the canister 170. In some embodiments, the combined lengths of opposing relief structures 100 can be equal to any number between 5% and 99% of the inside diameter of the canister 170.

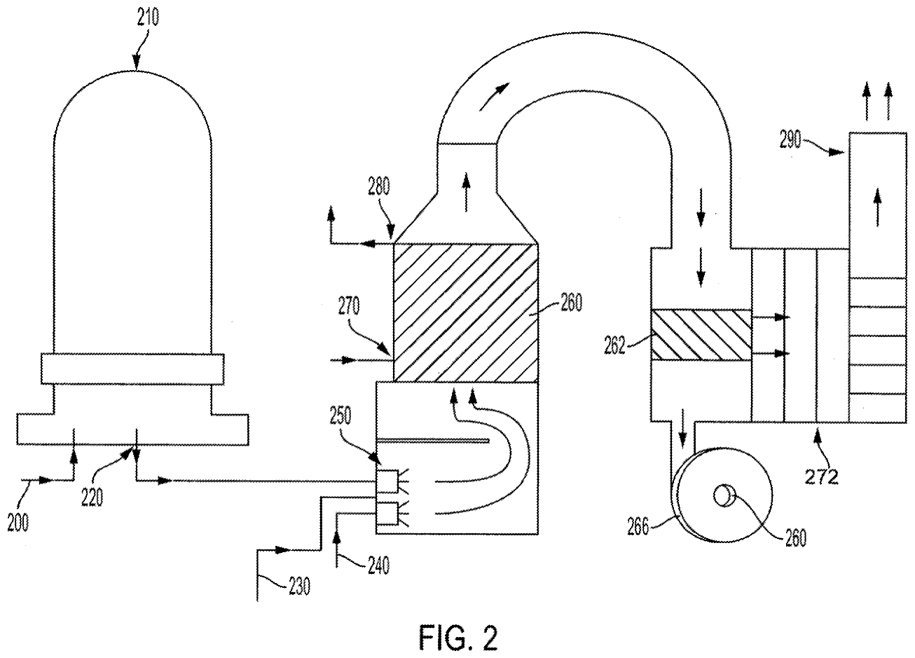

An overview of one embodiment of the present teachings is provided in FIG. 2, with the autoclave 210 containing a canister filled with MSW at the left hand side. Air 200 for the thermal conversion of the MSW is added to the autoclave and the resulting enhanced BTU syngas 220 is produced. The syngas can then be mixed, as necessary to sustain combustion, with a secondary fuel 240 such as diesel, natural gas or propane, and air 230, and then combusted in a burner assembly 250 to produce heated gas. The heated gas can then be sent through a heat exchanger 260 to transfer its energy to an Organic Rankine Cycle (“ORC”) or steam boiler to produce electricity. The heated gas can then pass through an air cleaning assembly for subsequent release to the environment.

Components of the cylindrical canisters can be assembled of stainless steel or low carbon steel depending on the structural requirements of the environment. The grates, support structures, and the compression relief structures can be composed of, for example, low carbon steel, stainless steel, or other suitable steel or metal alloys.

Temperatures and pressures during the thermal conversion process can be monitored by means of heat and pressure sensors located throughout the autoclave. The sensors can be located at the top dome, the top, middle and bottom of the canister, the inner shield and the various process lines entering and leaving the autoclave. The sensors can be installed using known methods through the walls of the autoclave to allow for measurements of reactor conditions during the thermal conversion process.

One embodiment of the presently disclosed process involves placing a carbon pillow into the bottom of the canister to provide a layer between the ignition gas and the MSW. The carbon can be ignited by the heated air, and thereby turn into a thermal layer. Thus, the MSW is not contacted directly with the heated air from the heater but rather the carbon pillow is ignited which in turn begins the thermal conversion of the MSW. During downdraft cycles, the thermal layer will still continue upwards thru the MSW while the process gases will pass down thru the carbon layer. It is understood that as the gases pass through the carbon layer any aromatic cyclical hydrocarbon ring compounds present can be broken down.

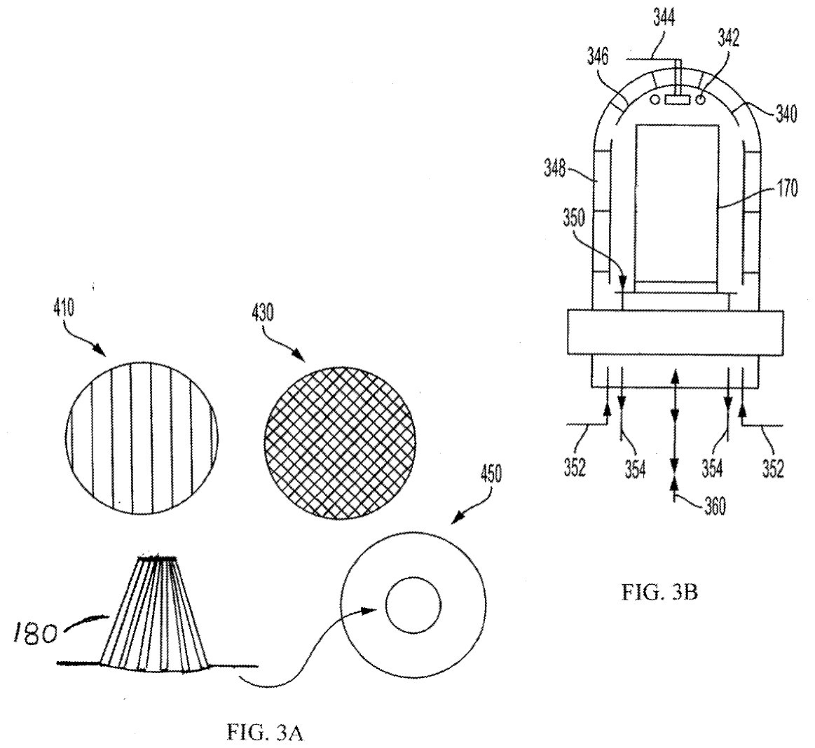

The bottom of the canister in the autoclave can be located directly above the gas heater chamber. In some embodiments of the presently taught system, the top of the gas heater chamber can be equipped with a solid metal ring 450 to enable the thermal decomposition process to be started and maintained more easily. The plate can have an appropriately sized hole in the middle thereof to allow for proper ventilation of the gas heater area. A canister section can have a grate 410 or wire mesh 430 assembly at its end portion. The grid properties can vary dependent on the properties of the MSW contained in the canister section. This arrangement is illustrated in more detail in FIGS. 1 and 3.

The heated air chamber located at the bottom of the autoclave can be equipped with a conical shaped heat deflector which can be composed of an appropriate metal to withstand the conditions, for instance, stainless steel. The heat deflector or conical structure 180 can be in a fluted cone shape as shown in FIG. 3A. The bottom of the canister can be located above the highest part of the heat deflector to provide enough room from the bottom of the canister to the top of the heat deflector for the thermal conversion process to generate enough heat and air flow to allow for the creation of a thermal layer in the MSW present in the canister.

As shown in FIG. 3A, the canister can be equipped with a substantially closed bottom 450 with a center opening for the heated air to be introduced there through. In some embodiments of the present teachings, the bottom of the canister can be equipped with a grating or perforated floor, 410, 430, to permit air flow. Additionally, the canister can have a conical structure 180 projecting up from the circumference of the center opening. A carbon pillow can be positioned around the conical structure to enhance the initial thermal decomposition process.

The carbon pillow can be composed primarily of charcoal. The carbon pillow (not shown) can be positioned around and over the conical structure 180 and over the grated floor structure 430. The carbon pillow can be thick enough that the heated air does not directly impact the solid waste material during the initial start-up operation of the thermal decomposition process. For illustrative purposes, in some instances, the carbon pillow can be ten inches or more in depth. The solid waste material is thermally converted to syngas during the presently disclosed thermal decomposition process, and does not come into direct contact with the heated air.

The canister can have a perforated or grated floor bottom structure (see 410, 430 and 450 of FIG. 3A) that can be constructed so that the floor can support the bale of compressed MSW or other materials deposited therein to be thermally processed. The bottom structure can include reinforcing bars or supports across the canister. Additionally, the bottom structure can support any non-processed materials that remain after the thermal decomposition process is stopped, and prevent them from falling out of the canister.

The canister can be equipped with air vents 120 at appropriate locations to control the thermal reaction within the canister. These air vents can be set, in some instances, to a desired level prior to the insertion of the filled canister into the autoclave. In some embodiments of the canisters, the top of the canister and the vents 120 can both, independently of one another, be present during the thermal decomposition process.

One possible embodiment of the presently disclosed autoclave or MSW processor is further illustrated in FIG. 3B. As seen in FIG. 3B, the autoclave provides for various inputs and outputs 342, 344, 352, 354, during the thermal conversion cycle with at least one compressed air inlet 352, at least one atomized water inlet 342, quenching water 344, at least one counter flow control outlet 354, at least one inlet for heated air 360, and at least one outlet for the produced syngas 360. In FIG. 3B, the thermal shield 346 is attached to the autoclave by at least posts 340, ceramic coating 348 can be on the interior of the autoclave, and a heat reflective plate 350 is under the canister. In some embodiments of the present teachings, the inlets and outlets for the various components can be shared, that is, the component moving through a particular opening can be varied dependent on the stage of the process.

The cylindrical canisters can be sized to accommodate bales of compressed MSW. These bales typically weigh from between 1000 to 2600 pounds. The bales can be produced in various dimensions. Typically the bales are 3 to 5 feet high, but can be as tall as 12 feet high, the bale diameter can be about 4 to 5 feet. The presently disclosed system is not limited to a certain size or dimension of the baled MSW but can be sized, larger or smaller, to accommodate the size of the available bales. Properties such as conversion efficiencies or increased BTU value of the gas may be impacted by the bale size.

In some embodiments of the present teachings, the MSW can be baled without sorting of the waste, and in other embodiments the waste can be sorted on the basis of its BTU content. Thus, high density BTU waste materials, plastics and rubber-containing items, like tires, can be separated from lower density BTU waste material like newspaper, food or yard waste. The separated items can be compressed into separate bales, or in some embodiments, the separated items can be re-mixed to obtain an MSW mixture with an average baseline BTU content in each bale.

Similar to the various waste materials added to the bales, liquid waste materials can also be added to both baled and unbaled MSW alike. Liquid wastes such as used motor oils or lubricants can increase the BTU content of the waste material.

In some embodiments, unsorted MSW can be then loaded into a canister which in turn is placed into the autoclave. The waste can be placed loosely into a canister and/or compressed bales may be placed into the canister. Preferably the bales are cylindrical and sized to fit in the canisters of the present teachings. The bales can be compressed between 100 and 1000 psi, and then wrapped in a protective material to maintain the compressed condition.

The various waste feedstreams leading into the baler can include a variety of possible separated recycled or refuse components including food wastes, lawn and garden waste, plastics, rubber, liquid oil, grease, lubricants, processing liquid wastes, or other hydrocarbon-containing liquids or gels.

In some instances, larger size metal pieces can be introduced into the material to be baled. One reason for adding the metal pieces is to minimize dead zones inside the bale where material does not readily thermally decompose. This phenomenon is seen on an irregular basis during the presently disclosed process. While the exact mechanism of why decomposition does not occur has not been fully developed, it is currently understood that the introduction of void spaces can increase the efficiency of the decomposition process and decrease dead zones. The addition of the metal pieces can increase void spaces, also provide hot spots and increase conduction of thermal energy into more densely packed waste material.

The EPA (U.S.) broadly defines MSW as containing “everyday items such as product packaging, yard trimmings, furniture, clothing, bottles and cans, food, newspapers, appliances, electronics and batteries.” Typical sources of MSW include residential, commercial, and institutional sites. Although, the EPA's definition excludes industrial, hazardous, and construction and demolition waste, such as rubble, for the present disclosure such wastes, including tires, are included in the definition of MSW. When handling certain classes of MSW, handling safeguards should be implemented to avoid undesirable side effects and contamination arising from the wastes.

A reactor for the thermal decomposition of waste material is also taught by the present disclosure. The reactor can contain a canister, a floor structure at the bottom of the canister, a heated air opening for heated air introduction located in the floor structure in the canister, and a conical structure centrally positioned above the heated air opening. The present reactor can be placed into an autoclave suitable of holding the canister.

The conical structure centrally positioned above the heated air opening can have a carbon pillow positioned around the conical structure, and be configured to prevent the heated air from directly contacting the waste material. As set forth above, the carbon pillow can be, in some embodiments of the presently disclosed system, ten inches or more thick. One purpose of the carbon pillow is to prevent direct impact of the heated air on the compressed or loose MSW.

In some embodiments, the canister can have a floor structure comprising a grated structural component configured to allow for airflow and support for the waste material. Of particular interest is preventing partially thermally decomposed material from falling out of the canister.

For the canister, the floor structure can be a solid plate having a central heated air opening, and in some cases, a grated structural component can be located above the solid plate and its central heated air opening.

As set forth above, provisions can be made for introducing additional air and water into the disclosed reactor to control the thermal decomposition process, thus the canister can include openings for venting of process gas, or introduction of additional reaction components.

A sealable reactor vessel generally suitable for used with the presently disclosed method can include the apparatus generally described in the applicant's prior patent, U.S. Pat. No. 8,715,582 B2, the disclosure of which is incorporated by reference herein in its entirety for all purposes.

All publications, articles, papers, patents, patent publications, and other references cited herein are hereby incorporated by reference herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What is claimed is:

1. A reactor for thermal processing of waste materials, the reactor comprising:
a canister having an interior defined by a wall;
at least one support structure mounted on the wall; and
at least one compression relief structure pivotally attached to a respective one of the support structures;
wherein the compression relief structure is pivotable between a first position that is parallel to the wall, and a second position that is orthogonal to the wall.

2. The reactor according to claim 1, wherein the support structures are located at a midplane of the canister.

3. The reactor according to claim 1, comprising support structures located at two levels of the canister,
wherein one level is at approximately one-third of the canister, and a second level is at approximately two-thirds of the canister.

4. The reactor according to claim 1, wherein the least one support structure comprises 2 or more symmetrically spaced support structures around the internal circumference of the canister.

5. The reactor according to claim 4, wherein the combined lengths of diametrically opposing compression relief structures comprise up to any one of 99%, 90%, 80%, 70%, 60%, 50%, 40%, 30%, 20%, 10%, or 5% of the inside diameter of the canister.

6. The reactor according to claim 4, wherein the combined lengths of diametrically opposing compression relief structures comprise any number between 5% and 99% of the inside diameter of the canister.

7. The reactor according to claim 4, further comprising a compression relief structure pivotally attached to each one of the symmetrically spaced support structures.

8. The reactor according to claim 1, when the canister is in an upright vertical position, the compression relief structure is pivotable between a first position that is parallel to the wall, and a second position that is orthogonal to the wall.

9. The reactor according to claim 1, when the canister is in an inverted vertical position, the compression relief structures pivot to a first position parallel to the wall.

10. The reactor according to claim 1, wherein the least one support structures mounted on the wall are located irregularly.

11. The reactor according to claim 1, further comprising:
a floor structure at a bottom of the canister;
a heated air opening located in the floor structure of the canister, and a conical structure centrally positioned above the heated air opening.

12. The reactor according to claim 11, further comprising:
a carbon pillow positioned around the conical structure configured to prevent the heated air from directly contacting the waste material.

13. A reactor for thermal processing of waste material comprising:
a canister having an interior defined by a wall;
a floor structure at a bottom of the canister;
a heated air opening located in the floor structure of the canister;
a conical structure centrally positioned above the heated air opening, and
a carbon pillow positioned around the conical structure configured to prevent heated air from directly contacting the waste material.

14. The reactor according to claim 13, further comprising an autoclave suitable for holding the canister.

15. The reactor according to claim 13, further comprising:
one or more support structures mounted on the wall of the canister, and
a compression relief structure pivotally attached to a respective one or more of the support structures,
wherein the compression relief structure prevents compression of waste materials loaded into the canister.

16. The reactor according to claim 13, wherein the floor structure comprises a grated structural component configured to allow for airflow and support for the waste material.

17. The reactor according to claim 13, wherein the floor structure comprises a solid plate having a central opening.

18. A canister for the thermal decomposition of waste material, the canister comprising:
a canister having an interior defined by a wall;
support structures mounted on the wall;
compression relief structure pivotally attached to a respective one or more of the support structures;
a floor structure at a bottom of the canister;
a heated air opening located in the floor structure of the canister;
a conical structure centrally positioned above the heated air opening, and
a carbon pillow positioned around the conical structure configured to prevent the heated air from directly contacting the waste material,
wherein the compression relief structure prevents compression of waste materials loaded into the canister.

19. The canister according to claim 18, wherein the compression relief structure is pivotable between a first position that is parallel to the wall, and a second position that is orthogonal to the wall.

20. The canister according to claim 18, where the waste material comprises a cylindrical bale of compressed solid and liquid waste wrapped with a protective material to maintain the waste in a compressed condition, and loose municipal solid waste.
